(19) United States
(12) Patent Application Publication
(10) Pub. No.: US 2007/0271047 A1
(43) Pub. Date: Nov. 22, 2007

(54) Method of power factor correction

(76) Inventors: Allen Y. Tan, Taipei City (TW); H. P. Yee, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/434,771

(22) Filed: May 17, 2006

(51) Int. Cl. G06F 19/00

(52) U.S. Cl. 702/64; 702/1; 702/57; 702/66; 702/71

(57) ABSTRACT

A method of power factor correction is disclosed. The method uses the slope of the voltage waveform to determine the phase angle of the voltage. Based on the phase angle, a current waveform is generated that is in phase with the voltage. The slope of the voltage signal is calculated as the derivative of voltage with respect to time. The resultant current signal is in ratio with the voltage signal. Additionally, the current signal has zero or near zero phase displacement with respect to the voltage signal. Repeatedly performing the steps of the method allows a continuous current signal to be provided. As load characteristics change, the method quickly adapts the power to compensate. As a result, reliable and effective power factor correction is achieved.

### BACKGROUND OF THE INVENTION

1. Field of the Invention

The present invention relates to a power supply. More specifically, the present invention discloses a method of power factor correction that determines the slope of the voltage signal to simulate a current curve with zero phase displacement.

2. Description of the Prior Art

A conventional power factor correction PFC technique is to have the power supply input resemble a resistor. This is achieved by programming the input current in response to the input voltage. With a cost ration between the voltage and the current the input will be resistive. This provides a power factor equal to one.

However, distortion or phase displacement in the input can occur if the ratio is not constant. Distortion or phase displacement will negatively affect the power quality.

The convention method of power factor correction increases the power factor to ensure that the phase angle between the current and the voltage approaches zero. Unfortunately, this technique is not always achievable in practice.

As shown in FIG. 1A, in an alternating current circuit, the current signal 120 will follow the voltage signal 110 if the load is simply resistive. This means that when the maximum voltage is across the load the maximum current flows. When the voltage reverses so, does the current.

However, as shown in FIG. 1B, complex alternating current loads are not always this simplistic. In actuality the current signal 120 does not precisely follow the voltage signal 110 because the load is inductive, capacitive, or a combination which varies over time. As the complexity of the load increases, the phase displacement between the current and the voltage increases. As a result, the power factor is reduced and the power supply is less effective.

Most conventional methods of PFC use a reference to generate a current that is power factor corrected. This reference is usually obtained by multiplying a scaled replica of the rectified line voltage vg times the output of the voltage error amplifier, which sets the current reference amplitude. In this way, the reference signal is naturally synchronized and proportional to the line voltage, which is the condition needed in order to obtain unity power factor.

One conventional PFC method is peak current control. In this method the switch is turned on via a constant clock signal and is turned off when the sum of the positive ramp of the inductor current and an external ramp or compensating ramp reaches the sinusoidal current reference.

Peak current control methods typically operate in continuous current mode CCM for reduced input filter requirement. The diodes used in the diode bridge can also be slow switching diodes because the bridge diodes only need to block at line frequency. However, the freewheel diode in the boost converter needs to be fast switching.

Refer to FIG. 1C, which is a diagram illustrating a current waveform of a conventional average current control method.

Another conventional PFC method is average current control. This method provides a better current waveform as the control is based on the average rather than the peak. The inductor current is sensed and filtered by a current error amplifier whose output drives a pulse width modulation PWM modulator. The inner current loop tends to minimize the error between the average input current and the reference. However, average current control operates on a constant switching frequency and has the same requirements for diodes as the peak current control method.

Refer to FIG. 1D, which is a diagram illustrating a current waveform of a conventional discontinuous current PWM control method.

A third type of conventional PFC is discontinuous current PWM control. In this method the switch is operated at constant on-time and frequency without an inner current loop. With the converter working in discontinuous conduction mode DCM, this control technique allows unity power factor when used with converter topologies like flyback. However, because of the discontinuous current, this method can cause harmonic distortion in the line current.

Therefore, there is need for a reliable and efficient method of power factor correction that is utilized in a power supply or power source system.

### SUMMARY OF THE INVENTION

To achieve these and other advantages and in order to overcome the disadvantages of the conventional method in accordance with the purpose of the invention as embodied and broadly described herein, the present invention provides a method of power factor correction that uses the slope of the voltage signal to simulate a current curve in order to provide a sinusoidal current signal in phase with the voltage signal.

The power factor is commonly defined as the ratio of total active power to total apparent power in volt-amperes. As noted, frequently the current waveform is not sinusoidal and is out of phase with the voltage. In order to overcome this issue, a current supply which provides a current waveform in phase with the voltage is required.

Active power factor correction attempts to make the input to a power supply appear like a resistor. This can be achieved by programming the input current in response to the input voltage. Maintaining the ratio between the voltage and current constant, the input will be resistive and the power factor will equal one.

An object of the present invention is to provide a method of power factor correction so that the phase angle between the current and the voltage approaches zero.

Another object of the present invention is to provide a reliable and efficient method of power factor correction. A sample of the sinusoidal voltage is taken. Next, the slope of the tangent of this point on the curve of the voltage signal is determined.

From a plurality of voltage samples, a curve of the voltage signal can be determined and a current signal can be simulated. In this way an active power factor correction technique is achieved and a current signal in phase with the voltage signal is provided.

Another object of the present invention is to provide a power factor correction method that can be easily implemented in an integrated circuit.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a graph illustrating in-phase voltage and current signals in a resistive circuit;

FIG. 1B is a graph illustrating out-of-phase voltage and current signals in a varying load circuit;

FIG. 1C is a diagram illustrating a current waveform of a conventional average current control method;

FIG. 1D is a diagram illustrating a current waveform of a conventional discontinuous current PWM control method;

FIG. 2 is a flowchart illustrating a method of power factor correction according to an embodiment of the present invention;

FIGS. 3A-3C are graphs illustrating determining the slope of a non-linear signal;

FIG. 4A is a graph illustrating a voltage signal over time; and

FIG. 4B is a graph illustrating a resultant current signal obtained by the method of power factor correction according to an embodiment of the present invention.

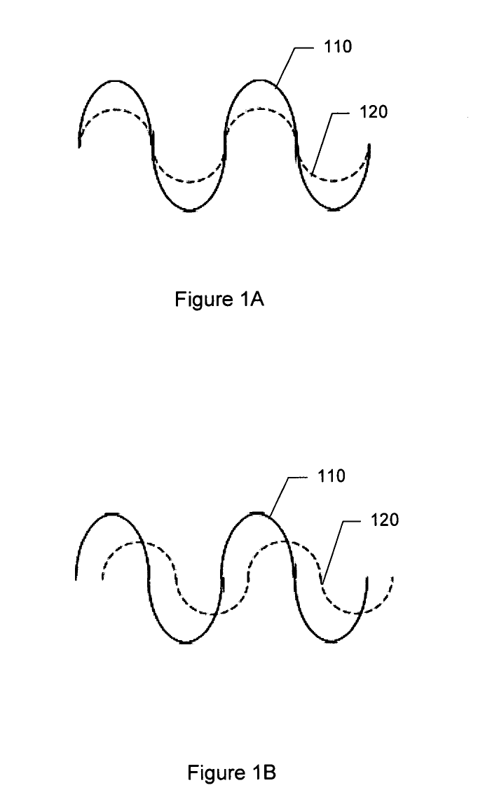

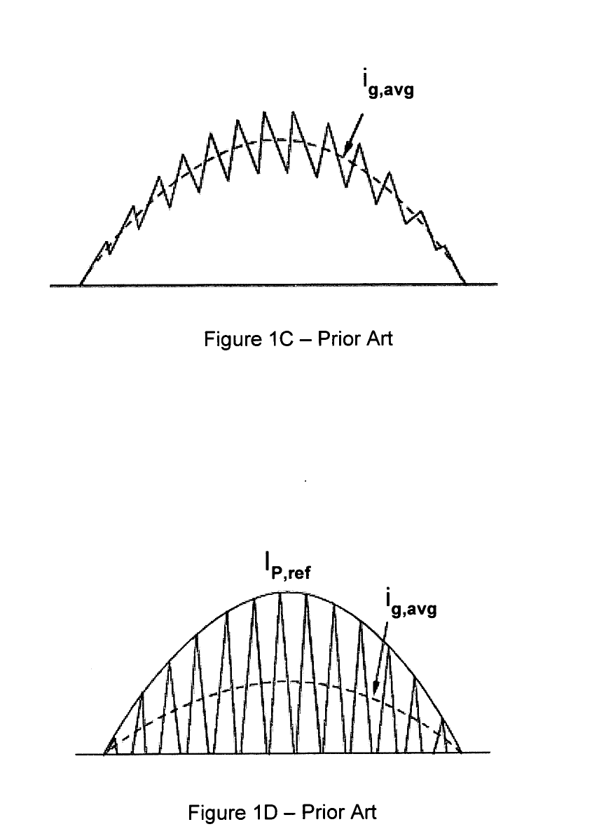

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

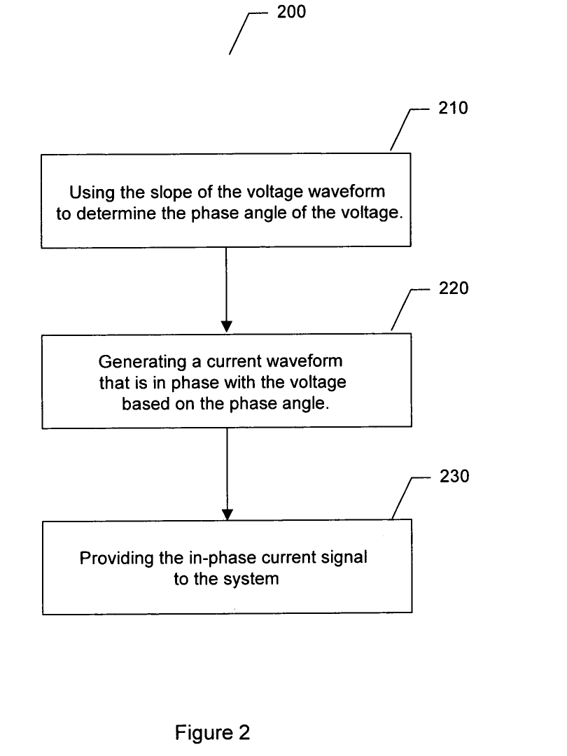

Refer to FIG. 2, which is a flowchart illustrating a method of power factor correction according to an embodiment of the present invention.

As shown in FIG. 2, the method 200 begins by using the slope of the voltage waveform to determine the phase angle of the voltage in Step 210. From this phase angle of the voltage, a current waveform is generated that is in phase with the voltage in Step 220. The in-phase current waveform is then provided to the rest of the system in Step 230.

By repeating the steps above, any change in load characteristics will immediately be compensated for by the present invention in order to provide a sinusoidal current signal with zero phase displacement.

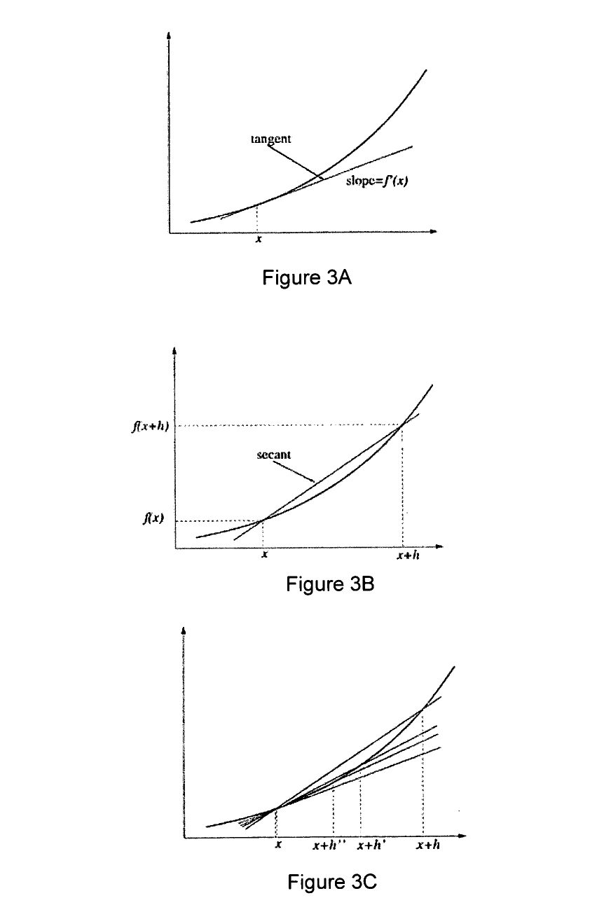

Refer to FIGS. 3A-3C, which are graphs illustrating determining the slope of a non-linear signal.

In an embodiment of the present invention the slope is determined by the following method. The derivative of a function f at x is the slope of the tangent line to the graph off at x. Since only one point is know from the sample, the tangent line is approximated with multiple secant lines. The secant lines have a progressively shorter distance between the intersecting points. The slope of the tangent line is obtained by taking the limit of the slopes of the nearby secant lines. The derivative is determined by taking the limit of the slope of secant lines as they approach the tangent line. The derivative of f at x is the limit of the value of the difference quotient as the secant lines get closer and closer to be a tangent line.

The slope of the line through the points (x, f(x)) and (x+h, f(x+h)) shown in FIG. 3C is (f/(x+h)−f(x))/h.

Therefore, the slope of the voltage sample can be determined by the equation dvldt or the derivative of voltage over the derivative of time or in other words, the derivative of voltage with respect to time.

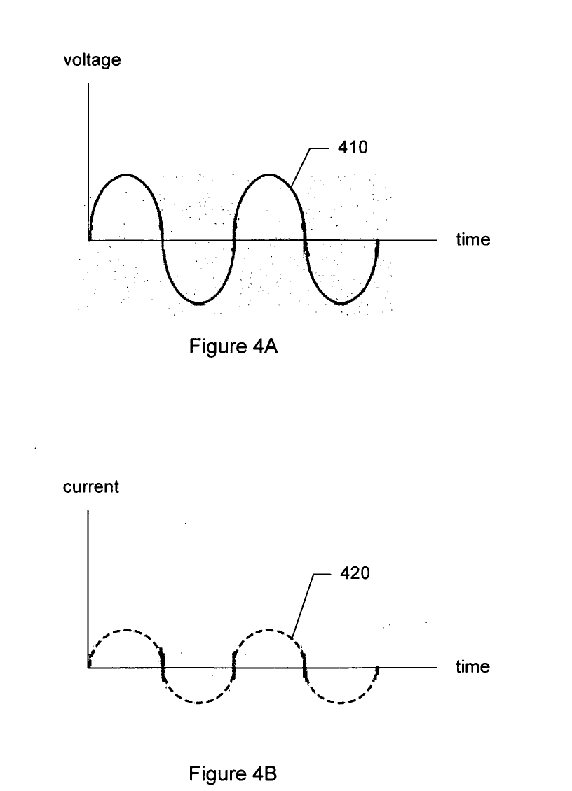

Refer to FIG. 4A which is a graph illustrating a voltage signal over time and to FIG. 4B, which is a graph illustrating a resultant current signal obtained by the method of power factor correction according to an embodiment of the present invention.

As shown in FIGS. 4A and 4B, the current signal is in-phase and in ratio to the voltage signal. The number of voltage samples can be predetermined according to requirements. In situations where high accuracy is required, more samples can be taken.

In another embodiment of the present invention the slope of the voltage signal is obtained by taking two voltage samples. Next the slope of the voltage signal is calculated as voltage at second sample minus voltage at first sample divided by time at second sample minus time at first sample.

The accuracy of the method in this embodiment is mainly dependant on the frequency of samples taken. The more frequent the samples, the more accurate the resultant current signal is.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of power factor correction comprising the steps of:
using a slope of a voltage waveform to determine a phase angle of the voltage; and
generating a current waveform that is in phase with the voltage based on the phase angle of the voltage.

2. The method of power factor correction of claim 1, further comprising providing the current waveform to a load.

3. The method of power factor correction of claim 1, where the slope of the voltage waveform is calculated as the derivative of voltage with respect to time.

4. The method of power factor correction of claim 1, where the slope of the voltage waveform is calculated after taking two samples as voltage at second sample minus voltage at first sample divided by time at second sample minus time at first sample.

5. The method of power factor correction of claim 1, where the method is incorporated into an integrated circuit.

6. The method of power factor correction of claim 1, further comprising repeating the steps in order to create a continuous current signal.

7. The method of power factor correction of claim 1, where phase difference between the voltage waveform and the current waveform is zero.

8. A method of power factor correction comprising the steps of:
determining a slope of a voltage signal;
using the slope of the voltage signal to determine a phase angle of the voltage signal; and
generating a current signal that is in phase with the voltage signal based on the phase angle of the voltage signal.

9. The method of power factor correction of claim 8, where the slope of the voltage signal is calculated as the derivative of voltage with respect to time.

10. The method of power factor correction of claim 8, where the slope of the voltage signal is calculated after taking two samples as voltage at second sample minus voltage at first sample divided by time at second sample minus time at first sample.

11. The method of power factor correction of claim 8, further comprising repeating the steps in order to create a continuous current signal.

12. The method of power factor correction of claim 8, where the method is incorporated into an integrated circuit.

13. The method of power factor correction of claim 8, where phase difference between the voltage signal and the current signal is zero.

14. A method of power factor correction comprising the steps of:
determining a slope of a voltage waveform;
determining a phase angle of the voltage waveform based on the slope;
generating a current waveform in phase with the voltage waveform based on the phase angle; and
repeating the steps in order to provide a continuous current signal.

15. The method of power factor correction of claim 14, where the slope of the voltage waveform is calculated as the derivative of voltage with respect to time.

16. The method of power factor correction of claim 14, where the slope of the voltage waveform is calculated after taking two samples as voltage at second sample minus voltage at first sample divided by time at second sample minus time at first sample.

17. The method of power factor correction of claim 14, further comprising providing the current waveform to a load.

18. The method of power factor correction of claim 14, where the method is incorporated into an integrated circuit.

19. The method of power factor correction of claim 14, where phase angle between the voltage signal and the current signal is zero.
